(19) United States
(12) Patent Application Publication
(10) Pub. No.: US 2007/0141916 A1
(43) Pub. Date: Jun. 21, 2007

(54) Automatic-opening containing device

(76) Inventor: Shih-Shin Chen, Taipei (TW)

Correspondence Address: SHIH-SHIN CHEN, P.O. BOX 26-757, TAIPEI, R.O.C., 106, TW

(21) Appl. No.: 11/311,975

(22) Filed: Dec. 21, 2005

(51) Int. Cl. H01R 24/04

(52) U.S. Cl. 439/668

(57) ABSTRACT

An automatic-opening containing device includes a base casing, a fixing casing relative to the base casing, a movable casing arranged around the fixing casing, a set of control circuits, a motor arranged inside a control portion of the fixing casing and controlled by the set of control circuits to drive the movable casing, a lid covering the control portion, and a secure member connecting the motor, the fixing casing and the movable casing together. The fixing casing has a first opening formed thereof, and the movable casing has a second opening formed thereof and a three-dimensional configuration similar to that of the fixing casing. The fixing casing and movable casing are concentric in order to generate the largest possible opening when the first and second openings completely overlap. The fixing casing and the movable casing do not interfere with each other when the movable casing rotates.

### BACKGROUND OF THE INVENTION

1. Field of The Invention

The present invention relates to an automatic-opening container device.

2. Description of the Related Art

Up to the present, for improving the convenience and hygiene of a container, complex mechanical structures have been applied. Conventional structures coupled with circuits have been disadvantaged because of their high cost, unstable structure and marketing problems. A conventional automatically-opening garbage bin includes a set of electrical circuit boards to drive a motor, which makes a small gear rotate to lift a lid thereof, thereby the automatic opening of the conventional garbage bin is achieved.

These shortcomings have prevented manufacturers from producing a garbage bin with an integrated system.

### SUMMARY OF THE INVENTION

An automatic-opening containing device that has a simple structure, and is cheap as well as highly stability, is provided.

The automatic-opening containing device includes a base casing, a fixing casing relative to the base casing, a movable casing arranged annularly around the fixing casing, a set of control circuits, a motor arranged inside a control portion of the fixing casing and controlled by the set of control circuits to drive the movable casing, a lid covering the control portion, and a secure member connecting the motor, the fixing casing and the movable casing together. The fixing casing has a first opening formed thereof, and the movable casing has a second opening formed thereof and three-dimensional configuration similar to that of the fixing casing. The fixing casing and movable casing are concentric in order to generate the largest possible opening when the first and second openings completely overlap. The fixing casing and the movable casing do not interfere with each other when the movable casing rotates.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a bottom explosion view of an automatic-opening containing device according to the present invention;

FIG. 2 is a top explosion view of an automatic-opening containing device according to the present invention; and

FIG. 3 is a perspective view of the automatic-opening containing device according to the present invention.

### DETAILED DESCRIPTION OF PREFERRED EMBODIMENTS

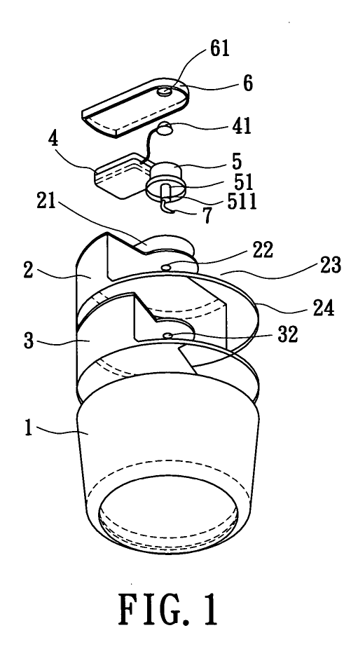

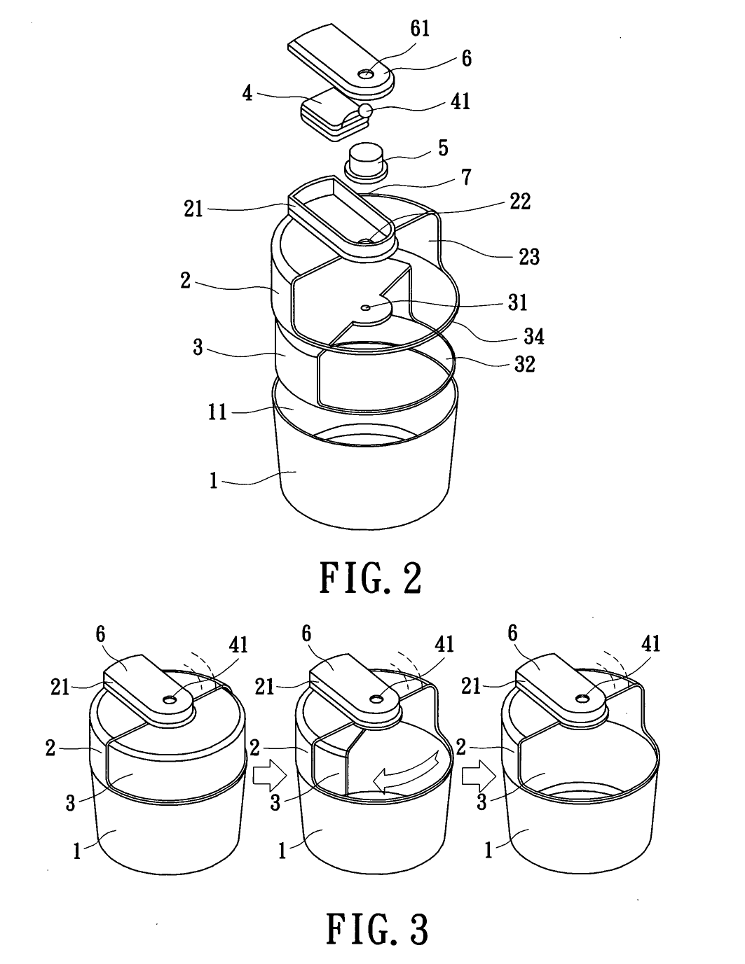

Reference is made to FIG. 1, which is a bottom explosion view of an automatic-opening containing device according to the present invention. The automatic-opening containing device includes a base casing 1, a fixing casing 2, a movable casing 3, a set of control circuits 4, a motor 5, a lid 6 and a secure member 7. The base casing 1 is made of plastic or metallic materials. The base casing 1 is hollow and has a casing opening 11 facing a rim 24 of the fixing casing 2. The fixing casing 2 is relative to the base casing 1. The fixing casing 2 without a control portion 21 is defined with a three-dimensional configuration, which is similar to that of the movable casing 3. The movable casing 3 is received inside the fixing casing 2. The fixing casing 2 and the movable casing 3 are concentric in order to generate the largest possible opening. The fixing casing 2 and the movable casing 3 do not interfere with each other when the movable casing 3 rotates. The fixing casing 2 is made of plastic or metallic materials. The fixing casing 2 includes a control portion 21 arranged on a top thereof, and the control portion 21 is opposite to the movable casing 3.

The set of control circuits 4 and the motor 5 are disposed inside the control portion 21. Of course, the set of control circuits 4 can be arranged in a different place according to the needs of the user. The fixing casing 2 and the movable casing 3 can be columned, semispherical or conical. The motor 5 has a driving shaft 51 penetrating a circular hole 22, which stands at the center. The motor can further include a variable gear to adjust the opening speed thereof.

The movable casing 3 is made of plastic or metallic materials. The movable casing 3 is arranged annularly around the fixing casing 2. The movable casing 3 can be received inside or outside of the fixing casing 2. The movable casing 3 includes a non-circular hole 31, which is shaped like the driving shaft 51 of the motor 5. The movable casing 3 is arranged inside the fixing casing 2. The driving shaft 51 of the motor 5 penetrates through the circular hole 22 of the fixing casing 2 and the non-circular hole 31 of the movable casing 3 sequentially, then the secure member 7 (in this case the secure member 7 is a pin) penetrates through a through hole 511 of the driving shaft 5 so that the motor 5, the fixing casing 2 and the movable casing 3 are made as a whole to operate simultaneously. The secure member 7 may be altered by a C typed retaining ring or by a screw bolt.

The lid 6 is made of plastic or metallic materials, and is connected to cover the control portion 21. Because the lid 6 is arranged over the control portion 21, the set of control circuits 4 and the motor 5 arranged inside the control portion 21 are protected.

A sensor 41 of the control circuits 4 penetrates through a revealing hole 61 of the lid 6 so that the sensor 41 can detect movement. The set of control circuits 4 includes the sensor 41, a power source such as a battery set or an external power source, and other electronic components. Therefore, when the sensor 41 detects someone approaching, the control circuits 4 sends an order to rotate the movable casing 3 via the motor 5. When a second opening 32 of the movable casing 3 completely overlaps with a first opening 23 of the fixing casing 3, the control circuits 4 sends another order to stop the motor 5. The largest possible opening is formed due to the combination of the fixing and movable casings. When the sensor 41 detects someone leaving, the movable casing 3 rotates back to close the automatic-opening containing device. Therefore, the automatic-opening containing device is closed, and the content inside the automatic-opening containing device can be insulated from the environment. Thereby, smells are prevented from spreading throughout the nearby environment, the user doesn't have to touch the automatic-opening containing device so they don't come in contact with any germs, dirt or unpleasant materials providing a sanity solution for the disposal of garbage.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An automatic-opening containing device comprising:
a base casing;
a fixing casing being relative to the base casing, and having a control portion arranged on a top thereof, and a first opening formed thereof;
a movable casing arranged annularly around the fixing casing, and having a second opening formed thereof and a three-dimensional configuration similar to that of the fixing casing;
a set of control circuits;
a motor arranged inside the control portion and controlled by the set of control circuits to drive the movable casing;
a lid covering the control portion; and
a secure member connecting the motor, the fixing casing and the movable casing together;
wherein the fixing casing and the movable casing are concentric in order to generate the largest possible opening when the first and second openings completely overlap; and the fixing casing and the movable casing do not interfere with each other when the movable casing rotates.

2. The automatic-opening containing device as claimed in claim 1, wherein the movable fixing is arranged inside the fixing casing, and the fixing casing includes a control portion disposed thereon and opposite to the movable casing.

3. The automatic-opening containing device as claimed in claim 1, wherein the movable fixing is arranged outside the fixing casing, and the fixing casing includes a control portion disposed thereon and opposite to the movable casing.

4. The automatic-opening containing device as claimed in claim 1, wherein the fixing casing and the movable casing are columned, semispherical or conical.

5. The automatic-opening containing device as claimed in claim 1, wherein the secure member is a pin, a C typed retaining ring, or a screw bolt.

6. The automatic-opening containing device as claimed in claim 1, wherein the set of control circuits is powered by an external power or a battery set.

7. The automatic-opening containing device as claimed in claim 1, wherein the motor further includes a variable gear to adjust the speed thereof.
